(19) United States
(12) Patent Application Publication
(10) Pub. No.: US 2025/0137425 A1
(43) Pub. Date: May 1, 2025

(54) INTERCHANGEABLE INTAKE MANIFOLD ASSEMBLIES

(71) Applicant: Velossa Tech Engineering Inc., Davie, FL (US)

(72) Inventor: Dan Joseph Becker, Davie, FL (US)

(21) Appl. No.: 19/006,665

(22) Filed: Dec. 31, 2024

Related U.S. Application Data
(63) Continuation of application No. 16/785,609, filed on Feb. 9, 2020, now Pat. No. 12,180,916.

(51) Int. Cl. F02M 35/10; B60K 13/02; B60Q 1/44; B60R 19/52; F02M 35/16

(52) U.S. Cl. CPC F02M 35/10262; B60K 13/02; B60Q 1/442; B60R 19/52; F02M 35/10124; F02M 35/10144; F02M 35/10321; F02M 35/10327; F02M 35/10347; F02M 35/161

(57) ABSTRACT

An apparatus may comprise a base member defined by a rectangular aperture configured to receive and engage an automobile intake airbox. The base member may be further defined by a perimeter surrounding the rectangular aperture and having at least one fastener or aperture configured to receive a fastener dimensioned to avoid disturbing the automobile intake airbox. A gooseneck member may be fixedly attached to the base member. The gooseneck member may have a first end opening and a second end opening, with an interior cavity configured to direct air into the automobile intake airbox from the second end opening to the first end opening. An interchangeable bell housing may be removably secured to the second end opening of the gooseneck member. The interchangeable bell housing may have a frustoconical shaped cross section on at least one plane.

### RELATED APPLICATION

This application is a Continuation of U.S. application Ser. No. 16/785,609 filed on Feb. 9, 2020, which is incorporated by reference herein in its entirety.

It is intended that the above-referenced application may be applicable to the concepts and embodiments disclosed herein, even if such concepts and embodiments are disclosed in the referenced applications with different limitations and configurations and described using different examples and terminology.

### FIELD OF INVENTION

The present invention relates to devices, systems, and methods for an interchangeable intake manifold assembly and portions thereof.

### BACKGROUND OF THE INVENTION

Conventionally, intake manifold assembly upgrades to an automobile require cutting and/or altering the interior of an engine space, including sometimes permanent removal of engine components. For example, new intake manifold assemblies and portions thereof can require physically altering or replacing of an air box, installation of a cold air intake, cutting or drilling support structures, and other modifications to the interior of an engine bay.

Accordingly, there remains a need for interchangeable portions of intake systems. These and other needs are satisfied by the various aspects of the present disclosure.

### SUMMARY OF THE INVENTION

In accordance with the purposes of the invention, as embodied and broadly described herein, the invention, in one aspect, relates to an intake manifold assembly that facilitates interchangeable parts.

According to one aspect, an interchangeable intake manifold assembly is a high-performance ram air intake line of interchangeable components designed to boost performance of automobiles. The intake manifold assemblies offer the ability of a user to customize an inlet horn, flare, throat, or mouth, which is visible through the grill of the vehicle, adding an aggressive and aesthetically pleasing appearance. In general, the intake bell house includes a larger inlet, converging to the stock cowl inlet already present in the vehicle.

According to one aspect, the converging, coupled with the relative speed of the vehicle, will boost air pressure to the airbox. This boosting generally increases performance. The horn, flare, throat, or mouth also increase customer appreciation due to the aggressive and aesthetically pleasing visual properties.

In still further aspects, the invention also relates to methods for interchanging portions of intake manifold assemblies and variants thereof.

According to one aspect, an interchangeable intake assembly can include a base member being defined by a rectangular aperture configured to receive and engage an automobile intake box, with the base member being further defined by a perimeter surrounding the rectangular aperture and having at least one fastener or aperture configured to receive a fastener dimensioned to avoid disturbing the automobile intake box. The interchangeable intake assembly can also include a gooseneck member fixedly attached to the base member. The gooseneck member can have a first end opening and a second end opening. The gooseneck member can also have an interior cavity configured to direct air into the automobile intake box from the second end opening to the first end opening through the interior cavity. The interchangeable intake assembly can also include an interchangeable bell housing removably secured to the second end opening of the gooseneck member, with the interchangeable bell housing having a frustoconical shaped cross section on at least one plane.

According to another aspect, an interchangeable intake assembly can include a gooseneck member fixedly attached within an engine bay of an automobile, with the gooseneck member having a first end opening and a second end opening, and the gooseneck member having an interior cavity configured to direct air into an automobile intake airbox from the second end opening to the first end opening through the interior cavity. The interchangeable intake assembly can also include an interchangeable bell housing removably secured to the second end opening of the gooseneck member, with the interchangeable bell housing having a frustoconical shaped cross section on at least one plane.

According to yet another aspect, an interchangeable intake assembly may include a base member being defined by a rectangular aperture configured to receive and engage an automobile intake airbox. The rectangular aperture can comprise at least four rounded corners, with the base member being further defined by a perimeter surrounding the rectangular aperture and having two or more fasteners or apertures configured to receive fastener dimensioned to avoid disturbing the automobile intake airbox. The base member can be formed of a rigid material. The interchangeable intake assembly can further include a gooseneck member fixedly attached to the base member. The gooseneck member can include a first end opening and a second end opening, with the first end opening being in fluid communication with the rectangular aperture. The gooseneck member can also have an interior cavity configured to direct air into the automobile intake airbox from the second end opening to the first end opening through the interior cavity. The interchangeable intake assembly can also include an interchangeable bell housing removably secured to the second end opening of the gooseneck member, with the interchangeable bell housing having a frustoconical shaped cross section on at least one plane and configured to receive air through a forward automotive intake grille arranged in front of the interchangeable bell housing such that the interchangeable bell housing is visible through the forward automotive intake grille.

In some aspects, the techniques described herein relate to an interchangeable intake assembly, including a base member configured to engage an automobile intake airbox, and a gooseneck member fixedly attached to the base member. The gooseneck member may have a first end opening and a second end opening. A plurality of candidate bell housings may each be configured to be removably secured to the second end opening of the gooseneck member. Each candidate bell housing has a unique ornamental design visible through a forward automotive intake grille when installed on the gooseneck member.

In some aspects, the techniques described herein relate to an interchangeable intake system. The system may include a gooseneck member configured to attach to an automobile intake airbox, the gooseneck member having a first end opening and a second end opening. The system may further include a set of interchangeable bell housings, with each bell housing in the set configured to removably attach to the second end opening of the gooseneck member. Each bell housing in the set may have a unique external appearance.

In some aspects, the techniques described herein relate to an automobile intake assembly, including a base member configured to attach to an automobile intake airbox, and a gooseneck member configured to fixedly attach to the base member. The gooseneck member is configured to removably receive one of a plurality of ornamental bell housings.

Additional aspects of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several aspects of the invention and together with the description, serve to explain the principles of the invention.

FIG. 1A illustrates a front view of an automobile with an interchangeable intake manifold assembly installed thereon, according to an exemplary embodiment.

FIG. 1B illustrates a front view of the automobile of FIG. 1 with a grill portion removed for clarity of illustration, according to an exemplary embodiment.

FIG. 2A illustrates a front view of an interchangeable intake manifold assembly, according to an exemplary embodiment.

FIG. 2B illustrates a side view of an interchangeable intake manifold assembly, according to an exemplary embodiment.

FIG. 2C illustrates a rear perspective view of an interchangeable intake manifold assembly, according to an exemplary embodiment.

FIG. 2D illustrates a front perspective view of an interchangeable intake manifold assembly, according to an exemplary embodiment.

FIG. 3 illustrates an engine bay of an automobile prior to installation of an interchangeable intake manifold assembly, according to an exemplary embodiment.

FIG. 4 illustrates an engine bay of an automobile during installation of an interchangeable intake manifold assembly, according to an exemplary embodiment.

FIG. 5 is a flowchart of a method of installing an interchangeable intake manifold assembly, according to an exemplary embodiment.

FIG. 6 illustrates a front view of an automobile with an interchangeable intake manifold assembly installed thereon, according to an exemplary embodiment.

FIG. 7 illustrates a front view of an automobile with an interchangeable intake manifold assembly installed thereon, according to an exemplary embodiment.

FIG. 8 illustrates a front view of an automobile with an interchangeable intake manifold assembly installed thereon, according to an exemplary embodiment.

FIG. 9 illustrates a front view of an automobile with an interchangeable intake manifold assembly installed thereon, according to an exemplary embodiment.

FIG. 10 illustrates a front view of an interchangeable intake manifold assembly, according to an exemplary embodiment.

FIG. 11 illustrates a front view of an interchangeable intake manifold assembly, according to an exemplary embodiment.

FIG. 12 illustrates a front view of an interchangeable intake manifold assembly, according to an exemplary embodiment.

FIG. 13 illustrates a front view of an interchangeable intake manifold assembly, according to an exemplary embodiment.

FIG. 14 illustrates a front view of an interchangeable intake manifold assembly, according to an exemplary embodiment.

FIG. 15 illustrates a front view of an interchangeable intake manifold assembly, according to an exemplary embodiment.

FIG. 16 illustrates a front view of an interchangeable intake manifold assembly, according to an exemplary embodiment.

FIG. 17 illustrates a front view of an interchangeable intake manifold assembly, according to an exemplary embodiment.

### DETAILED DESCRIPTION OF THE INVENTION

The present invention can be understood more readily by reference to the following detailed description of the invention and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Any and all publications mentioned herein are incorporated herein by reference to disclose and describe the methods and/or materials in connection with which the publications are cited.

### A. Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used in the specification and the appended claims, the singular forms “a,” “an” and “the” include plural referents unless the context clearly dictates otherwise. Thus, for example, reference to “an assembly” includes two or more assemblies.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Disclosed are the components to be used to manufacture the disclosed devices and articles of the invention as well as the materials themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and Care disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the invention. Thus, if there are a variety of additional steps that can be performed it is understood that each of these additional steps can be performed with any specific aspect or combination of aspects of the methods of the invention.

It is understood that the devices and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

As used in the specification and the appended claims, shapes designated as triangular refer to all forms of triangles, including isosceles, right triangles, and others, unless explicitly narrowed to a particular triangle.

As used in the specification and the appended claims, shapes designated with the phrase “generally rectangular” refer to all forms of rectangular shapes, with two sets of evenly dimensioned sides, including parallelograms, perfect squares, true rectangles, and others, unless explicitly narrowed to a particular form of rectangle.

Furthermore, as used herein, the term “rectangle” and the individual term “rectangular” refers to a (plane) figure with four straight sides and four right angles, with equal or with unequal adjacent sides. A rectangle is a quadrilateral with four right angles. It can also be defined as an equiangular quadrilateral, since equiangular means that all of its angles are equal (360°/4=) 90°. It can also be defined as a parallelogram containing a right angle.

As used in the specification and the appended claims, shapes designated by other common terms such as, for example, star-like, oblong, rhomboid, and others, refer to every other similar shape that one of ordinary skill in the art would consider to be similar, unless particularly narrowed to an explicit version of the shape. For example, an equal-sided five-pointed star, or a rhomboid with at least two equally dimensioned sides, and other specific forms.

### B. Intake Manifold Assemblies

As described briefly above, the present disclosure relates, in various aspects, to devices and systems for an interchangeable intake manifold assembly.

The function of the intake manifold assembly is to allow air to reach an automobile engine, or any engine for that matter. Oxygen in the air is one of the necessary gases for the engine combustion process. A good air intake system allows for clean continuous airflow into the engine, thereby achieving more power and better mileage for an automobile. It is noted that interchangeable intake manifold assemblies as described herein are applicable to naturally-aspirated engines, super-charged engines, turbo-charged engines, and any engine using external air for a combustion process.

A modern car air intake system has three main components, amongst other components that vary among engine types. The first components include an air filter. The air filter removes debris and filters particulates to improve combustion. The air filter is usually a plastic or metal box in which the air filter resides. An additional component of a modern car air intake system is the mass flow sensor. The mass flow sensor is used to determine the mass of air entering of a fuel-injected internal combustion engine. From the mass flow sensor, air entering the vehicle travels through the throttle body. The throttle body is a portion of an air intake system that controls the amount of air flowing into an engine's combustion chamber. It consists of a housing that contains a throttle plate that rotates on a shaft or other pivot mechanism.

Located directly behind the front grill, an air intake system draws air into the air filter housing, and will be mixed with the car fuel. The air will be sent to the intake manifold that supplies the fuel/air mixture to the engine cylinders for appropriate combustion.

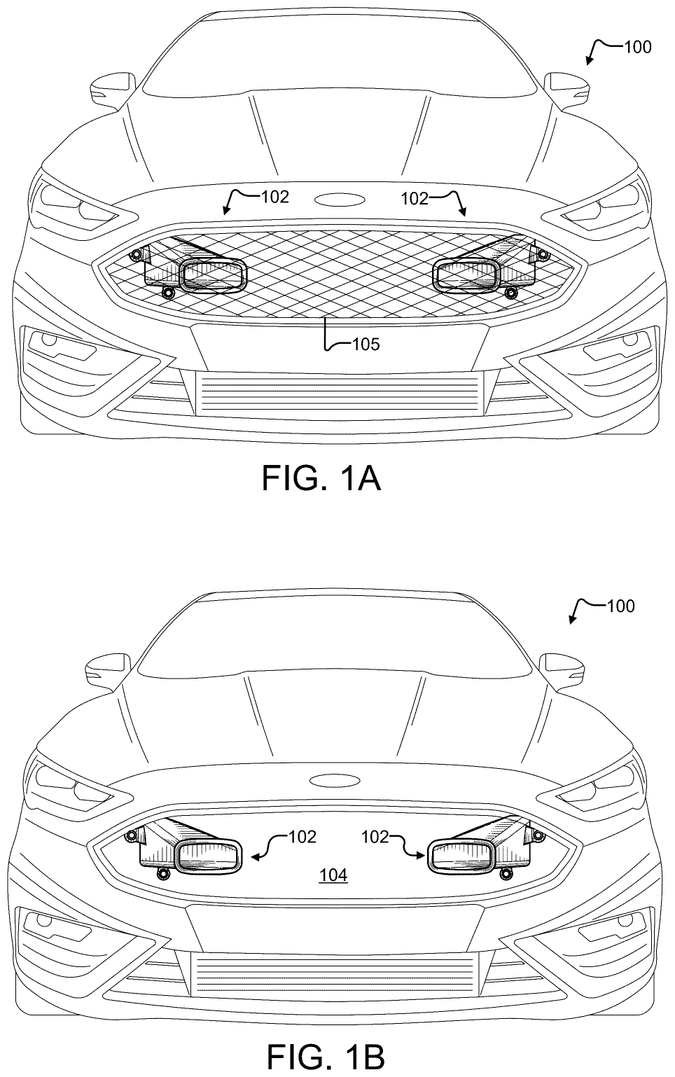

Turning now to the drawings, FIG. 1 a illustrates a front view of an automobile with an interchangeable intake manifold assembly installed thereon. As shown in FIG. 1 two interchangeable intake manifold assemblies have been installed rear of the forward intake grille 105, towards the left and right of the engine bay 104. Each interchangeable intake manifold assembly 102 includes a removable and interchangeable bell housing to change the appearance and the aesthetics of the automobile 100. For example, if main front grilles 105 is removed, as shown in FIG. 1B, the placement of the interchangeable intake manifold assembly 102 are more readily visible.

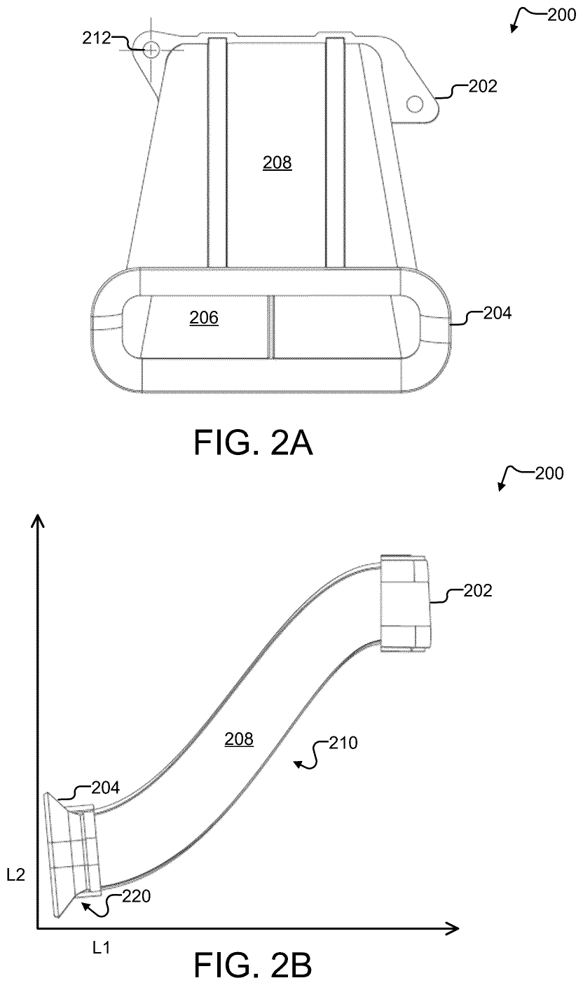

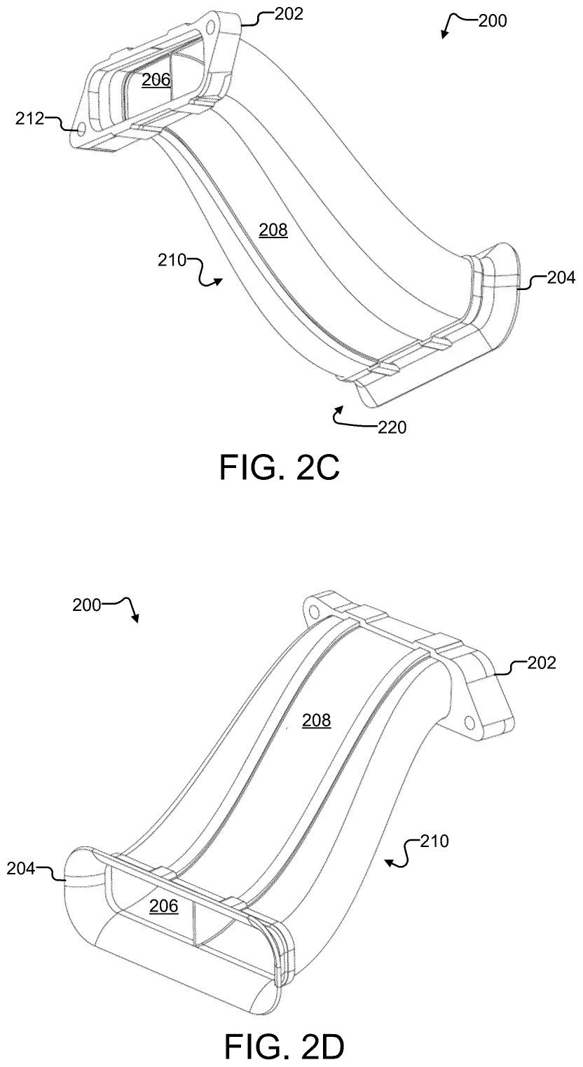

FIG. 2 a illustrates a front view of an interchangeable intake manifold assembly, according to an exemplary embodiment. As shown in FIG. 2A, the interchangeable intake manifold assembly 200 includes a base member 202 structurally attached to an exterior housing 208. The interchangeable intake manifold assembly 200 further includes a front bell housing 204 which is removable and interchangeable. Further, exterior housing 208 forms an interior cavity 206 to allow air to enter and be routed to a factory airbox.

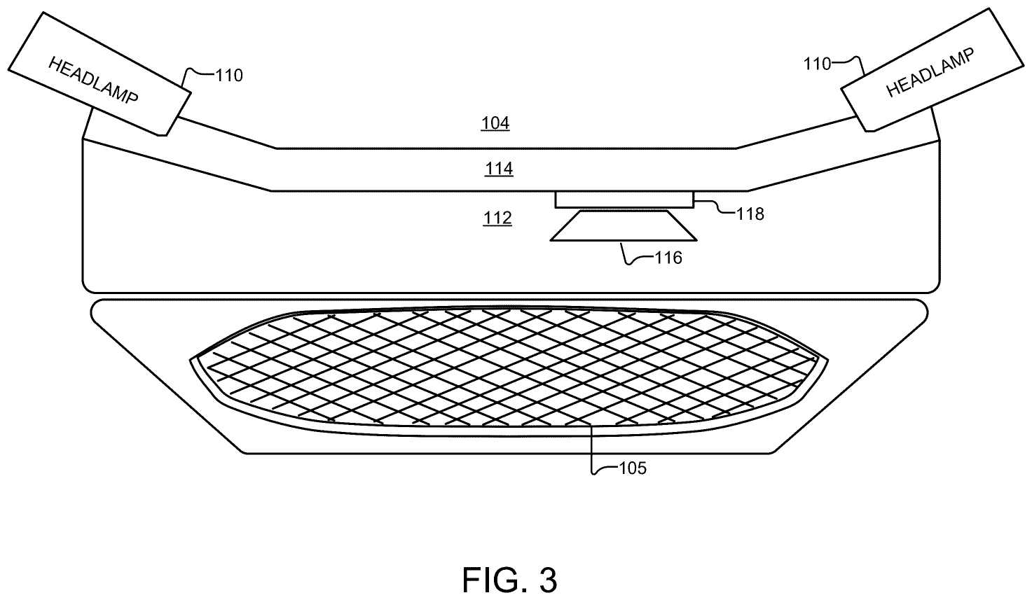

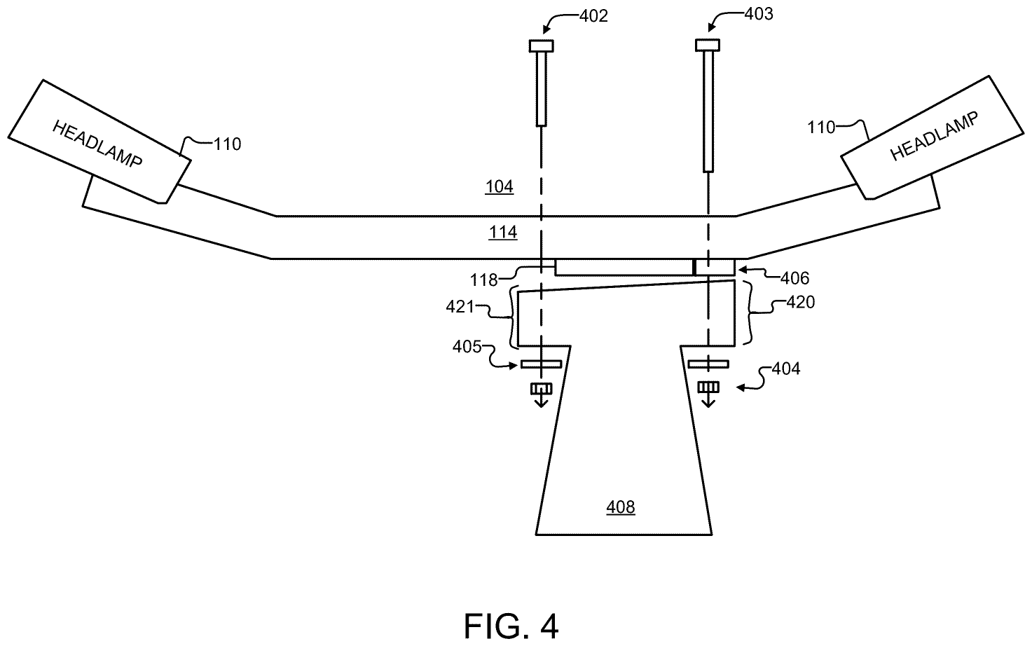

The interchangeable intake manifold assembly 200 also includes fastener or aperture 212 arranged for allowing the fastening of the interchangeable intake manifold assembly 200 to a standard automobile, with a standard airbox, without structural modifications to the engine bay 104. It is noted that, according to some aspects, trimming of the shroud (e.g., see FIG. 3 and FIG. 4; 112) may be necessary to install the interchangeable intake manifold assembly 200 to an automobile 100.

FIG. 2B illustrates a side view of an interchangeable intake manifold assembly, according to an exemplary embodiment. As shown, the gooseneck portion 210 has an overall vertical height of L2 and a horizontal width of L1. The horizontal width L1 allows the interchangeable intake manifold assembly 200 to be installed on a standard automobile—no matter how forward of the engine—without requiring cutting to route the front bell housing 204 behind the front grille.

Furthermore, the scooping cross-sectional area of the forward bell housing 204 allows the collection of air which is then forcibly passed through the interior cavity 206 formed by the exterior housing 208 such that it exits at the standard base member 202 for entry into the car's intake manifold.

FIG. 2C illustrates a rear perspective view of an interchangeable intake manifold assembly, and FIG. 2D illustrate a forward perspective view of the interchangeable intake manifold assembly 200, according to an exemplary embodiment. As shown, the downward arrangement of gooseneck member 210 allows for readily increased airflow while also allowing customization through a user's choice of the forward bell housing 204.

Accordingly, as illustrated in FIGS. 2A-2D, the interchangeable intake assembly 200 includes the base member 202. The base member 202 is defined by a rectangular aperture configured to receive and engage an automobile intake airbox.

The base member 202 is also defined by a perimeter surrounding the rectangular aperture and having at least one fastener or aperture 212 configured to receive a fastener dimensioned to avoid disturbing the automobile intake airbox.

The gooseneck member 210 is or may be fixedly attached to the base member 202. Additionally, the gooseneck member 210 has a first end opening and a second end opening. The gooseneck member 210 also has an interior cavity 206 configured to direct air into the automobile intake airbox from the second end opening to the first end opening through the interior cavity (e.g., from bell housing 204 to base member 202).

The interchangeable intake manifold assembly 200 also includes the interchangeable bell housing 204. The bell housing 204 may be removably secured to the second end opening of the gooseneck member 210 and/or exterior housing 208. The bell housing 204 may have a frustoconical shaped cross section on at least one plane intersecting the bell housing 204 on an axis orthogonal to initial airflow. More specifically, the bell housing 204 is bell shaped along at least one plane. According to some aspects, the bell housing 204 is truly bell-shaped, at least in cross section, but may have many frontal shapes.

According to some embodiments, the rectangular aperture at the base member 202 includes at least one rounded corner. According to other embodiments, the rectangular aperture includes at least four rounded corners configured to directly engage a standard automotive airbox. For example, some automotive manufacturers include an airbox with four rounded corners having clips or pins to retain the factory bell housing. The rectangular aperture may be dimensioned to engage the exterior of this portion of the airbox and have rounded corners at least partially matching this profile.

As shown in FIG. 2C, the base member 202 can be further defined by having a generally rectangular shape encompassing the perimeter portion and fastener or aperture 212. This generally rectangular shape can be a rhomboid or parallelogram dimensioned to engage existing fasteners or apertures configured to receive fasteners existing in an automobile.

As shown in FIGS. 1A-1B, and with reference to FIG. 2C, the gooseneck member 210 can be dimensioned to support the interchangeable bell housing 204 to be visible external to an automobile. For example, visibility may be through a forward intake grille 105. Accordingly, in some embodiments, the phrase “visible external to the automobile” refers to visibility behind a forward intake grille 105 of the automobile 100.

With regard to construction, the base member 202 and/or the gooseneck member 210 can be formed of metal, plastic, fused metal, 3-D printed material, or rigid material. Other material compositions may also be applicable. For example, rigid or semirigid rubber or hardened elastomers may be used in some applications. Furthermore, composite materials such as fiberglass or glass-reinforced resin or phenolic resin may be used. Still further, any rigid material capable of supporting the gooseneck member 210 and bell housing 204 may be applicable, as the interchangeable intake manifold assembly 200 is situated forward of the engine bay 104 and therefore not subject to typical engine temperatures in most applications.

Additionally, the interchangeable bell housing 204 may be formed of metal, plastic, injection-molded plastic, 3-D printed plastic, or a rigid material. The interchangeable bell housing 204 can also be formed of integrally formed colored material or coated in paint. For example, colorized plastic or rubber may be used in some applications. Still further, the integrally formed colored material or paint can be metallic or reflective.

Hereinafter, installation of an interchangeable intake assembly is described in detail. It is readily understood that alterations of the steps and/or methods of installation described may be applicable depending upon a particular model of automobile and/or whether the automobile is presently being modified and lacks some parts described below.

FIG. 3 illustrates an engine bay of an automobile prior to installation of an interchangeable intake manifold assembly, such as interchangeable intake manifold assembly 200, according to an exemplary embodiment. The illustrated view of the engine bay 104 is a top-down perspective, showing the forward intake grille 105, the stock bell housing 116, and the stock automobile intake airbox 118. Additionally, some automotive manufacturers install a shroud 112 (e.g., plastic shroud) that may obstruct the view of the stock bell housing 116. Finally, structurally, the standard or stock automobile intake airbox 118 is supported through the forward cowl 114.

Headlamps 110 are generally towards the left and right of the forward cowl 114 and may be supported therefrom. Additionally, the forward intake grille 105 may initially obstruct the view of the stock bell housing 116. Thus, the forward intake grille 105 and shroud 112 may be removed for better access to remove stock components and/or replace stock components.

FIG. 4 illustrates an engine bay of an automobile during installation of an interchangeable intake manifold assembly, such as interchangeable intake manifold assembly 200, according to an exemplary embodiment. As illustrated, two or more fasteners 402 and 403 are passed adjacent to the stock automobile intake airbox 118. Furthermore, a spacer component or spacer assembly 406 is included to receive the fastener 403.

The spacer allows the gooseneck member of an interchangeable intake manifold assembly to be appropriately situated due to the trapezoidal cross-section of the standard base member 202, denoted by 420 and 421. Upon mounting, spacer washer 405 and or fastener nut 404 may be tightened amongst fasteners 402, and 403 to finish installation. After installation, the interchangeable intake manifold assembly 408 may be customized using an interchangeable front bell housing, such as any bell housing described herein.

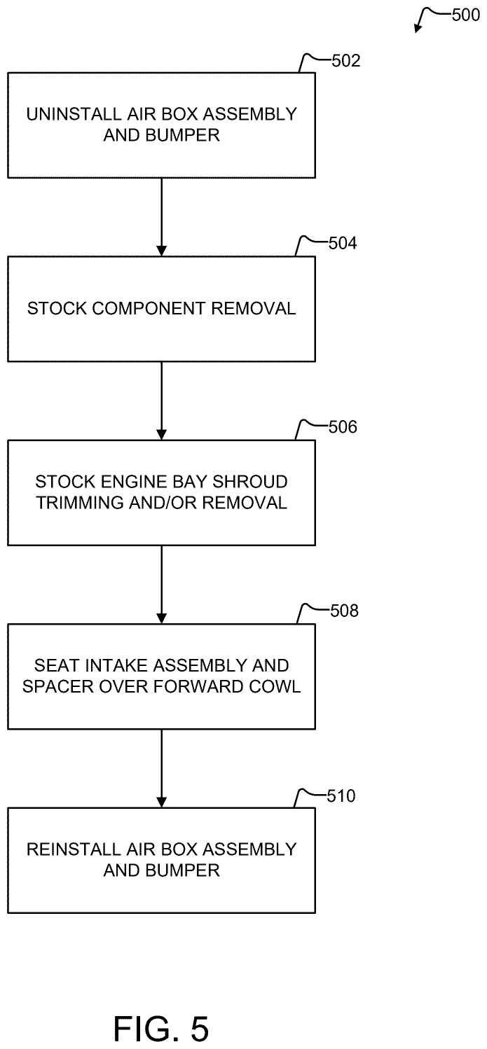

FIG. 5 is a flowchart of a method 500 of installing an interchangeable intake manifold assembly, according to an exemplary embodiment. The method 500 includes uninstalling a stock automobile intake airbox and front bumper/forward grille of an automobile at block 502. Upon access to the stock automobile intake airbox, the method 500 includes stock component removal of the factory or stock bell housing, at block 504.

The method 500 further includes trimming and/or removal of a stock engine bay shroud, if a user desires, at block 506. Thereafter, the method 500 includes seating the new interchangeable intake manifold assembly and spacer over the forward cowl utilizing the fasteners 402 and 403.

The method 500 further includes reinstalling an automobile intake airbox or assembly (if removed, and rearward of the base member 202) and front bumper or any decorative items removed from the front of the automobile, at block 510.

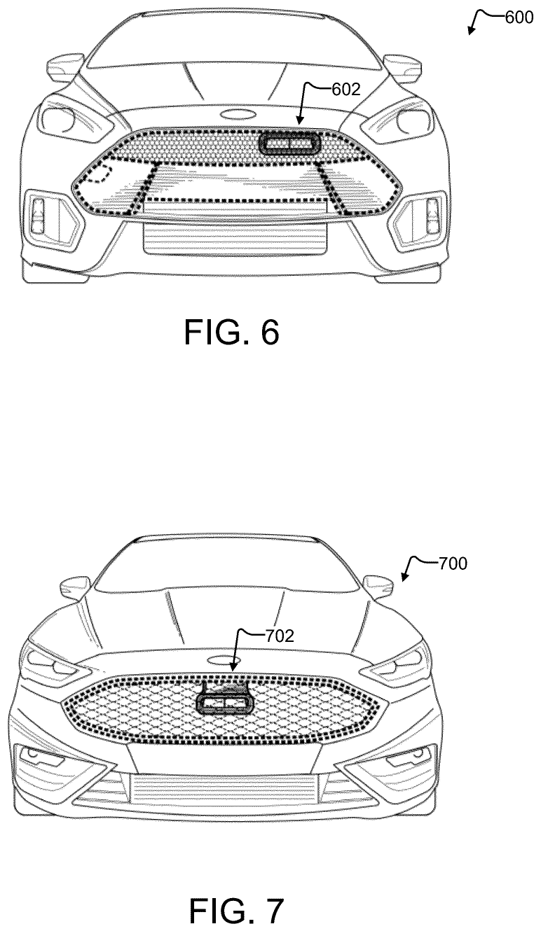

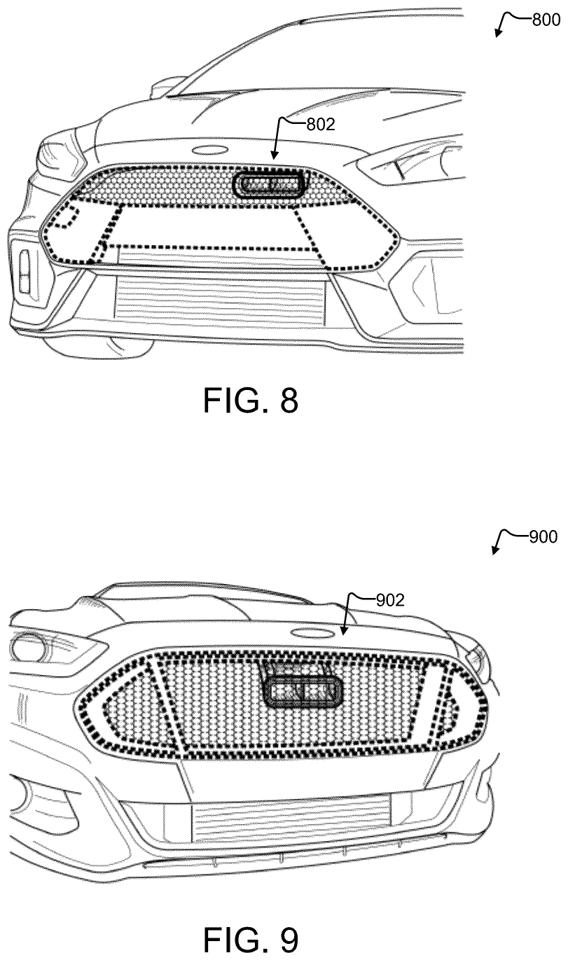

As illustrated in FIGS. 6-9, multiple physical locations for different interchangeable air intake assemblies 602, 702, 802, 902 may be chosen by a user of automobiles 600, 700, 800, and 900, depending on the aesthetic design and location of the stock automobile intake airbox.

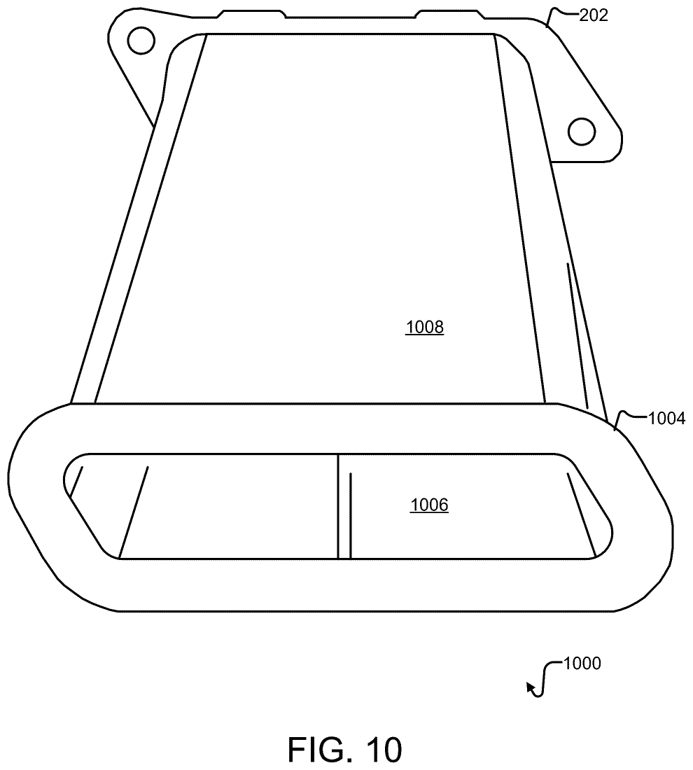

FIG. 10 illustrates a front view of an interchangeable intake manifold assembly, according to an example embodiment. As shown in FIG. 10, the interchangeable intake manifold assembly 1000 includes a common base member 202. Common base member 202 may be fixedly attached to exterior housing 1008. The exterior housing 1008 defines an interior cavity 1006 to receive intake air directed by the bell housing 1004.

Although the bell housing 1004 has a general parallelogram shape, it may be interchanged with several different bell housings to change the look, appearance, and aesthetics of a vehicle that it is installed in.

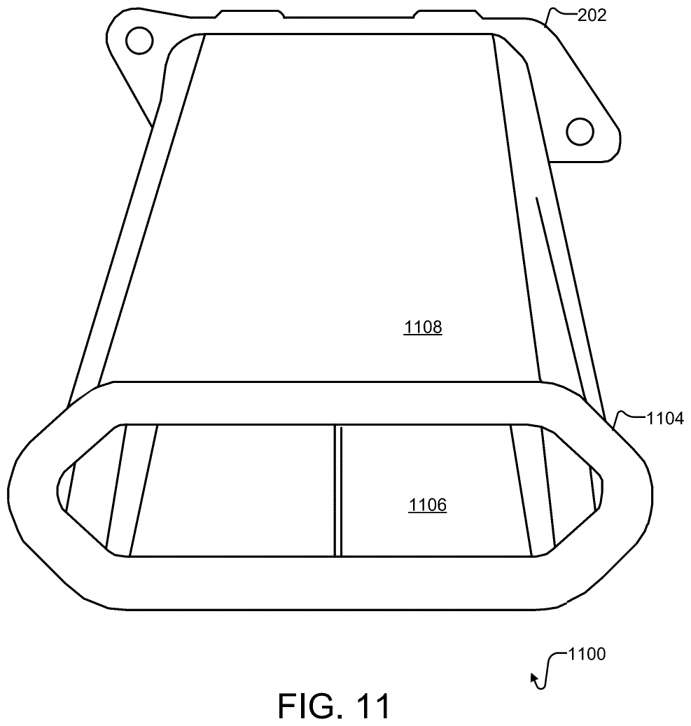

For example, FIG. 11 illustrates a front view of an interchangeable intake manifold assembly 1100. Interchangeable intake manifold assembly 1100 also includes the common base member 202, with the exterior housing 1108 fixedly attached thereto.

The exterior housing 1108 includes or defines an interior cavity 1106 configured to receive ram air from the bell housing 1104.

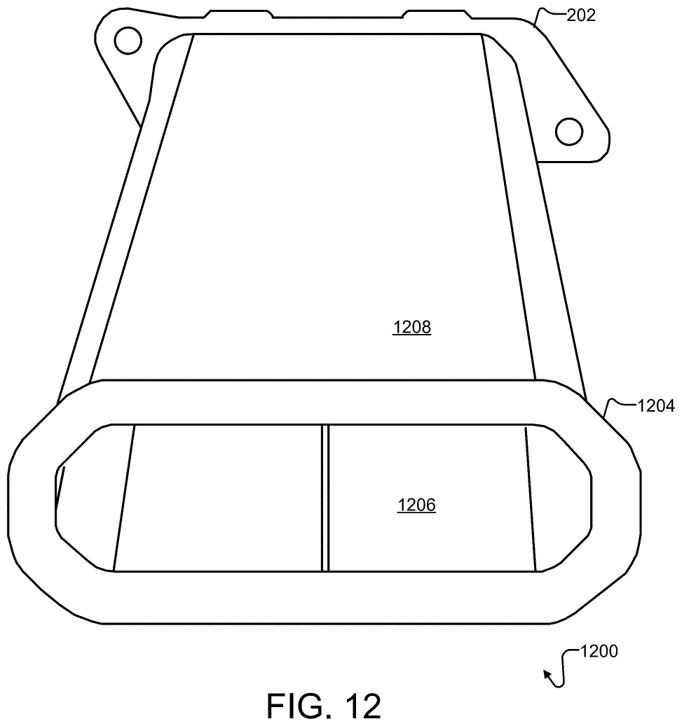

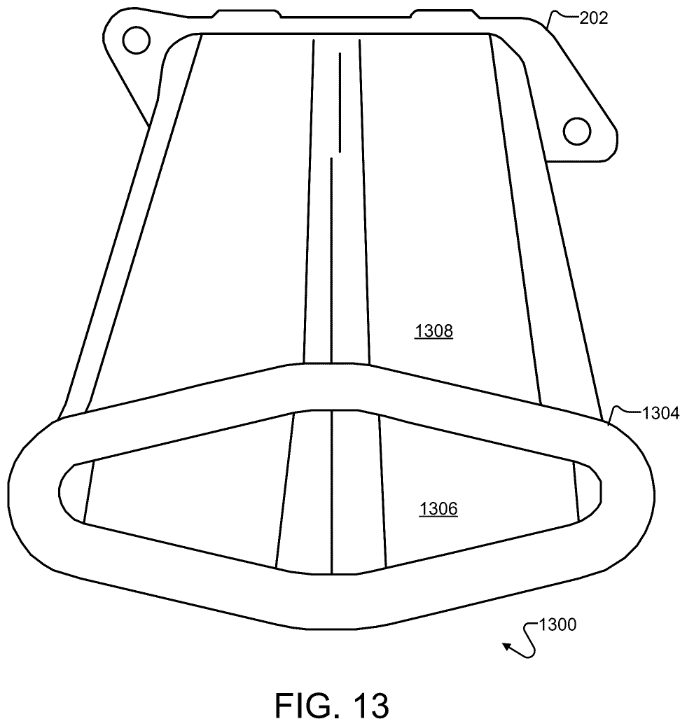

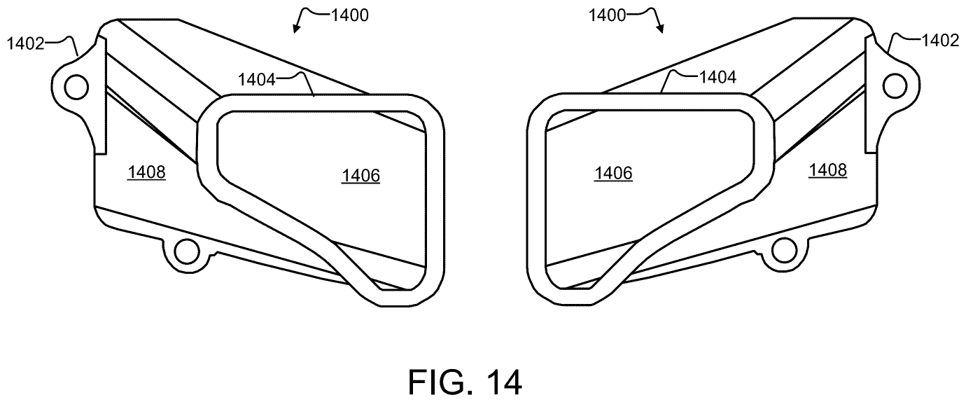

The bell housing 1104 is fully interchangeable without further modifications to the bell housing 1004. For example, as illustrated in FIGS. 12 and 13, each interchangeable intake manifold assembly includes the common base member 202 and the exterior housing 1208, 1308 fixedly attached thereto, which further defines an interior cavity 1206, 1306. The exterior housings 1208, 1308 are each configured to receive any of the bell housings 1004, 1104, 1204, 1304.

Moreover, additional designs and shapes are also possible. For example, additional bell housings can include virtually any shape, including but not limited to, rhomboids, perfect squares, rectangles, triangles, diamond shapes, star patterns, oblong or egg shapes, and any other suitable shape configurable to be attached to an exterior housing at least somewhat similar to exterior housing 1008, 1108, 1208, and/or 1308.

Turning now to FIG. 14 an additional front view of an interchangeable intake manifold assembly 1400 is illustrated. The interchangeable intake manifold assemblies 1400 are configured to be installed in a dual intake manifold system. The common backup base members 1402 may be fixedly attached to exterior housings 1408. Exterior housings 1408 are configured to receive a bell assembly or bell intake 1404 such that air is directed to interior cavities 1406, and further is received by the intake manifold(s) of an automobile.

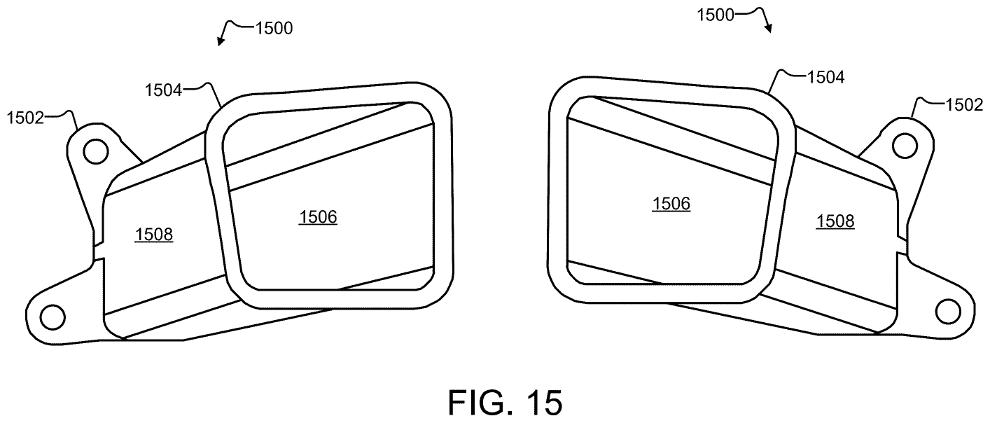

As illustrated in FIGS. 15-17, additional shapes and configurations of intake manifold assemblies are possible.

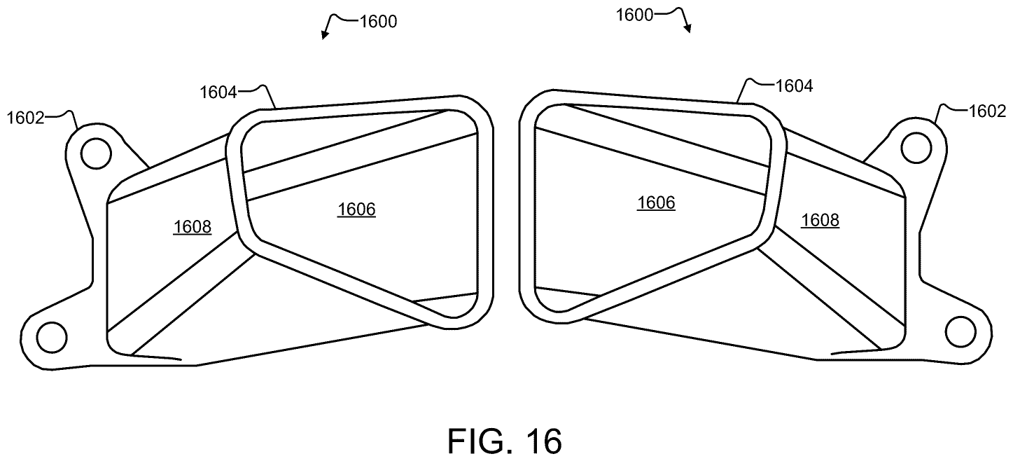

For example, as illustrated in FIG. 15, common base member 1502 is shared across interchangeable intake manifold assemblies 1500. As such, bell housings or ram air intakes 1504 and 1604 may be readily interchanged across the interchangeable intake manifold assemblies illustrated in FIG. 14, FIG. 15, and FIG. 16.

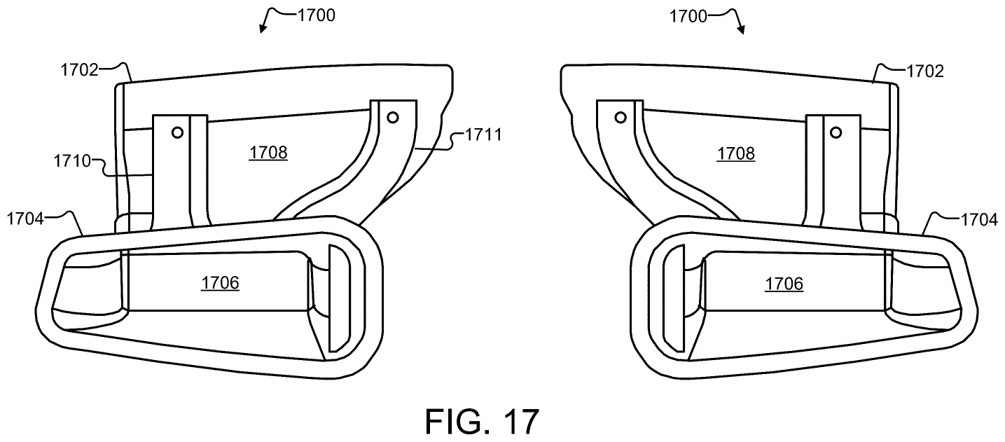

As shown in FIG. 17, additional forms of interchangeable intake manifold assemblies are available for different models of automobile. Interchangeable intake manifold assembly 1700 is configured for use in automobile with dual intakes and restricted space for installation.

For example, the interchangeable intake manifold assembly 1700 comprises a base member 1702, support structures 1710 and 1711, exterior housing 1708, which further defines an interior channel 1706 configured to receive ram air intake external to the automobile. Furthermore, interchangeable bell housing 1704 may be exchanged with any other shape bell housing to alter the appearance, aesthetics, and aggressive profile as desired by a consumer.

These and other features and functionality are included within the scope of exemplary embodiments of the present disclosure.

### C. Aspects

The present invention may include a plurality of aspects disclosed herein. For example, the following aspects may be included in one or more differing implementations of the present invention.

Aspect 1: An interchangeable intake assembly, comprising a base member being defined by a rectangular aperture configured to receive and engage an automobile intake box, the base member being further defined by a perimeter surrounding the rectangular aperture and having at least one fastener or aperture configured to receive a fastener dimensioned to avoid disturbing the automobile intake box; a gooseneck member fixedly attached to the base member, the gooseneck member having a first end opening and a second end opening, the gooseneck member having an interior cavity configured to direct air into the automobile intake box from the second end opening to the first end opening through the interior cavity; and an interchangeable bell housing removably secured to the second end opening of the gooseneck member, the interchangeable bell housing having a frustoconical shaped cross section on at least one plane.

Aspect 2: The interchangeable intake assembly of any preceding aspect, wherein the rectangular aperture includes at least one rounded corner.

Aspect 3: The interchangeable intake assembly of any preceding aspect, wherein the base member is further defined by having a generally rectangular shape encompassing the perimeter.

Aspect 4: The interchangeable intake assembly of any preceding aspect, wherein the generally rectangular shape is a rhomboid or parallelogram dimensioned to engage existing fasteners or apertures configured to receive fasteners existing in an automobile.

Aspect 5: The interchangeable intake assembly of any preceding aspect, wherein the gooseneck member is dimensioned to support the interchangeable bell housing to be visible external to an automobile.

Aspect 6: The interchangeable intake assembly of any preceding aspect, wherein visible external to the automobile comprises visibility behind a forward intake grille of the automobile.

Aspect 7: The interchangeable intake assembly of any preceding aspect, wherein the base member and the gooseneck member are formed of metal, plastic, fused metal, 3-D printed material, or rigid material.

Aspect 8: The interchangeable intake assembly of any preceding aspect, wherein the interchangeable bell housing is formed of metal, plastic, injection-molded plastic, 3-D printed plastic, or a rigid material.

Aspect 9: The interchangeable intake assembly of any preceding aspect, wherein the interchangeable bell housing is formed of integrally colored material or coated in paint.

Aspect 10: The interchangeable intake assembly of any preceding aspect, wherein the integrally formed colored material or paint is metallic or reflective.

Aspect 11: An interchangeable intake assembly, comprising a gooseneck member fixedly attached within an engine bay of an automobile, the gooseneck member having a first end opening and a second end opening, the gooseneck member having an interior cavity configured to direct air into an automobile intake airbox from the second end opening to the first end opening through the interior cavity; and an interchangeable bell housing removably secured to the second end opening of the gooseneck member, the interchangeable bell housing having a frustoconical shaped cross section on at least one plane.

Aspect 12: The interchangeable intake assembly of any preceding aspect, wherein the gooseneck member is dimensioned to support the interchangeable bell housing to be visible external to an automobile.

Aspect 13: The interchangeable intake assembly of any preceding aspect, wherein visible external to the automobile comprises visibility behind a forward intake grille of the automobile.

Aspect 14: The interchangeable intake assembly of any preceding aspect, wherein the base member and the gooseneck member are formed of metal, plastic, fused metal, 3-D printed material, or rigid material.

Aspect 15: The interchangeable intake assembly of any preceding aspect, wherein the interchangeable bell housing is formed of metal, plastic, injection-molded plastic, 3-D printed plastic, or a rigid material.

Aspect 16. An interchangeable intake assembly, comprising a base member being defined by a rectangular aperture configured to receive and engage an automobile intake airbox, the rectangular aperture comprising at least four rounded corners, the base member being further defined by a perimeter surrounding the rectangular aperture and having two or more fasteners or apertures configured to receive fastener dimensioned to avoid disturbing the automobile intake airbox, the base member being formed of a rigid material; a gooseneck member fixedly attached to the base member, the gooseneck member having a first end opening and a second end opening, the first end opening being in fluid communication with the rectangular aperture, the gooseneck member having an interior cavity configured to direct air into the automobile intake airbox from the second end opening to the first end opening through the interior cavity; and an interchangeable bell housing removably secured to the second end opening of the gooseneck member, the interchangeable bell housing having a frustoconical shaped cross section on at least one plane and configured to receive air through a forward automotive intake grille arranged in front of the interchangeable bell housing such that the interchangeable bell housing is visible through the forward automotive intake grille.

Aspect 17: The interchangeable intake assembly of any preceding aspect, wherein the base member is further defined by having a generally rectangular shape encompassing the perimeter.

Aspect 18: The interchangeable intake assembly of any preceding aspect, wherein the generally rectangular shape is a rhomboid or parallelogram dimensioned to engage existing fasteners or apertures configured to receive fasteners existing in an automobile.

Aspect 19: The interchangeable intake assembly of any preceding aspect, wherein the interchangeable bell housing has a rectangular bell shape to aid in receiving air through the forward automotive intake grill.

Aspect 20: The interchangeable intake assembly of any preceding aspect, wherein the interchangeable bell housing is formed of metal, plastic, injection-molded plastic, 3-D printed plastic, or a rigid material.

Aspect 21. An interchangeable intake assembly, comprising: a base member being defined by an aperture configured to receive and engage an automobile intake airbox, the base member being further defined by a perimeter surrounding the aperture and having at least one protrusion disposed on an outer portion of the perimeter, each of the at least one protrusion having at least one fastener or aperture configured to receive a fastener dimensioned to avoid disturbing the automobile intake airbox; a gooseneck member fixedly attached to the base member, the gooseneck member having a first end opening and a second end opening, the gooseneck member having an interior cavity configured to direct air into the automobile intake airbox from the second end opening to the first end opening through the interior cavity; a plurality of interchangeable candidate bell housings, each candidate bell housing configured to be interchangeably and removably secured to the second end opening of the gooseneck member, each interchangeable bell housing comprising: a frustoconical shaped cross section on at least one plane, and one or more grooves; and wherein the gooseneck member comprises one or more flanges disposed on an outer portion of the gooseneck member, each of the one or more flanges dimensioned to removably secure to one of the one or more grooves on a selected interchangeable bell housing, of the plurality of interchangeable candidate bell housings, by direct adjoinment on at least three sides.

Aspect 22. The interchangeable intake assembly of any preceding aspect, wherein the selected interchangeable bell housing is configured to be disengaged from the gooseneck member via removing the one or more flanges from the one or more grooves.

Aspect 23. The interchangeable intake assembly of any preceding aspect, wherein the selected interchangeable bell housing is removably secured to the second end opening of the gooseneck member via at least one fastener securing through the selected interchangeable bell housing and bottoming out in the gooseneck member further comprising at least one support protrusion disposed on an outer portion of the gooseneck member.

Aspect 24. The interchangeable intake assembly of any preceding aspect, wherein the base member is further defined by having a generally rectangular shape with rounded edges encompassing the perimeter.

Aspect 25. The interchangeable intake assembly of any preceding aspect, wherein the selected interchangeable bell housing is removably secured to the second end opening of the gooseneck member via directly adjoining four sides of an inner portion of the selected interchangeable bell housing threaded male portion securing to four sides of an exterior housing of the gooseneck member via a threaded female portion.

Aspect 26. The interchangeable intake assembly of any preceding aspect, wherein the selected interchangeable bell housing is removably secured, via clamshell fit, to the second end opening of the gooseneck member.

Aspect 27. The interchangeable intake assembly of any preceding aspect, wherein the selected interchangeable bell housing is removably secured to the second end opening of the gooseneck member via hook and loop.

Aspect 28. The interchangeable intake assembly of any preceding aspect, wherein the selected interchangeable bell housing is removably secured to the second end opening of the gooseneck member via friction fit.

Aspect 29. The interchangeable intake assembly of any preceding aspect, wherein the selected interchangeable bell housing is removably secured to the second end opening of the gooseneck member via a plurality of magnets.

Aspect 30. The interchangeable intake assembly of any preceding aspect, wherein the base member, the gooseneck member, and the plurality of candidate interchangeable bell housings are formed of a rigid material removably secured to the second end opening of the gooseneck member via an adhesive.

Aspect 31. An interchangeable intake assembly, comprising: a gooseneck member fixedly attached to an automotive intake airbox within an engine bay of an automobile, the gooseneck member having a first end opening and a second end opening, the gooseneck member having an interior cavity configured to direct air into an automobile intake airbox from the second end opening to the first end opening through the interior cavity; a plurality of candidate interchangeable bell housings, each interchangeable bell housing being configured to be removably secured to the second end opening of the gooseneck member via at least one fastener securing through the interchangeable bell housing and bottoming out in the gooseneck member, each candidate interchangeable bell housing having a frustoconical shaped cross section on at least one plane and one or more grooves; and wherein the gooseneck member comprises one or more flanges disposed on an outer portion of the gooseneck member, each of the one or more flanges being dimensioned to removably secure to one of the one or more grooves on a selected interchangeable bell housing, of the plurality of interchangeable candidate bell housings, by direct adjoinment on at least three sides.

Aspect 32. The interchangeable intake assembly of any preceding aspect, wherein the gooseneck member is dimensioned to support the selected interchangeable bell housing to be visible external to an automobile.

Aspect 33. The interchangeable intake assembly of any preceding aspect, wherein visible external to the automobile comprises visibility behind a forward intake grille of the automobile.

Aspect 34. The interchangeable intake assembly of any preceding aspect, wherein the plurality of candidate interchangeable bell housings, base member, and the gooseneck member are formed of metal, plastic, fused metal, 3-D printed material, or a rigid material.

Aspect 35. The interchangeable intake assembly of any preceding aspect, wherein the plurality of candidate interchangeable bell housings is formed of metal, plastic, injection-molded plastic, 3-D printed plastic, or a rigid material, and wherein each of the plurality of candidate interchangeable bell housings further comprises one or more protrusions at the first end opening secured to the automobile intake airbox via one or more fasteners.

Aspect 36. An interchangeable intake assembly, comprising: aa base member being defined by an aperture configured to receive and engage an automobile intake airbox, the base member being further defined by a perimeter surrounding the aperture and having one or more fasteners or apertures configured to receive the fasteners dimensioned to avoid disturbing the automobile intake airbox, the base member being formed of a rigid material; a gooseneck member fixedly attached to the base member, the gooseneck member having a first end opening and a second end opening, the first end opening being in fluid communication with the aperture, the gooseneck member having an interior cavity configured to direct air into the automobile intake airbox from the second end opening to the first end opening through the interior cavity; a plurality of candidate interchangeable bell housings, each of the candidate interchangeable bell housings being configured to be removably secured to the second end opening of the gooseneck member and having a frustoconical shaped cross section on at least one plane and one or more grooves and configured to receive air through a forward automotive intake grille arranged in front of the interchangeable bell housing when a selected interchangeable bell housing, of the plurality of candidate interchangeable bell housings, is installed on the gooseneck member, such that the selected interchangeable bell housing is visible through the forward automotive intake grille; and one or more flanges disposed on an outer portion of the gooseneck member, each of the one or more flanges dimensioned to interchangeably and removably secure to one of the one or more grooves of the selected interchangeable bell housing by direct adjoinment on at least three sides.

Aspect 37. The interchangeable intake assembly of any preceding aspect, wherein the base member is further defined by having a generally rectangular shape with rounded edges encompassing the perimeter.

Aspect 38. The interchangeable intake assembly of any preceding aspect, wherein the generally rectangular shape is a rhomboid or parallelogram dimensioned to engage existing fasteners or apertures configured to receive fasteners existing in an automobile.

Aspect 39. The interchangeable intake assembly of any preceding aspect, wherein at least one of the plurality of candidate interchangeable bell housings has a rectangular diamond bell shape to aid in receiving air through the forward automotive intake grill.

Aspect 40. The interchangeable intake assembly of any preceding aspect, wherein the plurality of candidate interchangeable bell housings, the base member, and the gooseneck member are each formed of metal, plastic, injection-molded plastic, 3-D printed plastic, or a rigid material.

### A. Claims

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications are referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein can be different from the actual publication dates, which can require independent confirmation.

The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An interchangeable intake assembly, comprising:
a base member configured to engage an automobile intake airbox;
a gooseneck member fixedly attached to the base member, the gooseneck member having a first end opening and a second end opening;
a plurality of candidate bell housings, each candidate bell housing configured to be removably secured to the second end opening of the gooseneck member; and
wherein each candidate bell housing has a unique ornamental design visible through a forward automotive intake grille when installed on the gooseneck member.

2. The interchangeable intake assembly of claim 1, wherein the base member comprises:
an aperture configured to receive the automobile intake airbox; and
a perimeter surrounding the aperture, the perimeter having at least one fastener or aperture configured to receive a fastener.

3. The interchangeable intake assembly of claim 1, wherein the gooseneck member comprises an interior cavity configured to direct air from the second end opening to the first end opening.

4. The interchangeable intake assembly of claim 1, wherein each candidate bell housing comprises a frustoconical shaped cross section on at least one plane.

5. The interchangeable intake assembly of claim 1, wherein each candidate bell housing comprises one or more grooves.

6. The interchangeable intake assembly of claim 5, wherein the gooseneck member comprises one or more flanges configured to engage the one or more grooves on a selected candidate bell housing.

7. The interchangeable intake assembly of claim 6, wherein the one or more flanges directly adjoin the one or more grooves on at least three sides.

8. The interchangeable intake assembly of claim 1, wherein each candidate bell housing is configured to be secured to the gooseneck member via at least one of:
a fastener;
a friction fit;
a clamshell fit;
hook and loop fasteners;
magnets; or
an adhesive.

9. The interchangeable intake assembly of claim 1, wherein the base member, gooseneck member, and plurality of candidate bell housings are formed of a rigid material.

10. The interchangeable intake assembly of claim 1, wherein the plurality of candidate bell housings comprises at least three candidate bell housings with different ornamental designs.

11. An interchangeable intake system, comprising:
a gooseneck member configured to attach to an automobile intake airbox, the gooseneck member having a first end opening and a second end opening;
a set of interchangeable bell housings, each bell housing in the set configured to removably attach to the second end opening of the gooseneck member; and
wherein each bell housing in the set has a unique external appearance.

12. The interchangeable intake system of claim 11, wherein the gooseneck member comprises an interior cavity configured to direct air from the second end opening to the first end opening.

13. The interchangeable intake system of claim 11, wherein each bell housing in the set comprises a frustoconical shaped cross section on at least one plane.

14. The interchangeable intake system of claim 11, wherein each bell housing in the set comprises one or more grooves configured to engage with one or more flanges on the gooseneck member.

15. The interchangeable intake system of claim 11, wherein the set of interchangeable bell housings comprises at least five bell housings with different external appearances.

16. An automobile intake assembly, comprising:
a base member configured to attach to an automobile intake airbox; and
a gooseneck member configured to fixedly attach to the base member, wherein the gooseneck member is configured to removably receive one of a plurality of ornamental bell housings.

17. The automobile intake assembly of claim 16, wherein the gooseneck member comprises:
a first end opening configured to fluidly connect to the base member;
a second end opening configured to removably receive one of the plurality of ornamental bell housings; and
an interior cavity extending between the first end opening and the second end opening.

18. The automobile intake assembly of claim 16, wherein each of the plurality of ornamental bell housings comprises:
a frustoconical shaped cross section on at least one plane; and
a unique external appearance visible through a forward automotive intake grille when installed on the gooseneck member.

19. The automobile intake assembly of claim 16, wherein:
the gooseneck member comprises one or more flanges; and
each of the plurality of ornamental bell housings comprises one or more grooves configured to engage with the one or more flanges on the gooseneck member.

20. The automobile intake assembly of claim 16, wherein the gooseneck member is configured to be secured to each of the plurality of ornamental bell housings via at least one of:
a fastener;
a friction fit;
a clamshell fit;
hook and loop fasteners;
magnets; or
an adhesive.
